(19) United States
(12) Patent Application Publication
(10) Pub. No.: US 2011/0281094 A1
(43) Pub. Date: Nov. 17, 2011

(54) MULTILAYER MODIFIED BITUMINOUS ROOFING PRODUCT

(76) Inventors: Natalino ZANCHETTA, Boca Raton, FL (US); Amir Khan, Winter Haven, FL (US)

(21) Appl. No.: 13/005,421

(22) Filed: Jan. 12, 2011

Related U.S. Application Data
(60) Provisional application No. 61/294,475, filed on Jan. 12, 2010.

(51) Int. Cl. B32B 11/04; B32B 7/02; B32B 5/00; B32B 17/10; B32B 27/08

(52) U.S. Cl. 428/215; 428/489; 428/440; 428/483; 428/220

(57) ABSTRACT

A dual-compound multi-protective-layer roofing material includes a factory-applied layer of SBS-modified bitumen compound on a lower layer, an APP-modified bituminous on an upper layer, and a carrier sheet disposed between the SBS-modified lower layer and the APP-modified upper layer.

### CROSS-REFERENCE TO RELATED APPLICATIONS

This application claims benefit to U.S. Provisional Patent Application Ser. No. 61/294,475, filed on Jan. 12, 2010, which is expressly incorporated herein in its entirety by reference thereto.

### FIELD OF THE INVENTION

This invention relates to bituminous roofing adapted for the waterproofing and sealing of substrate structures and to the method of manufacturing such materials. More particularly, the present invention is in the field of roofing membranes and shingles, having a factory-applied layer of styrene-modified bitumen layer on the bottom surface and a thermoplastic modifier such as atactic polypropylene modified bituminous compound on the top surface.

### BACKGROUND AND SUMMARY

It is well known to use bituminous compositions for manufacturing waterproofing membranes, generally for roof covering and roofing underlayments. Modified bituminous prepared roofing, also referred to as modified asphalt roofing membrane, may be manufactured using, as a core, a reinforcement carrier support sheet made of fabric such as polyester, fiberglass, or a combination of both, saturating and coating the front and back sides of the carrier with a modified bituminous coating material based on Atactic Polypropylene (APP), Amorphous Poly Alpha Olefin (APAO), Thermoplastic Polyolefin (TPO), Styrene-Butadiene-Styrene (SBS), Styrene-Ethylene-Butadiene-Styrene (SEBS), Styrene-Isoprene-Styrene (SIS), synthetic rubber or other asphaltic modifiers, that will enhance the properties of asphalt. Such membranes generally include only one modified bitumen material due mainly to compatibility issues among compounds.

Roofing membranes are used in commercial, industrial and residential applications. Two major classifications of modified bitumen roofing materials, which are used mostly in industrial and commercial applications are (1) cap sheet and (2) base sheet. Shingle roofing materials are used primarily in residential applications, and are exposed to the elements, and hence can be considered as “cap” as well. A cap sheet or shingle membrane can be modified using Atactic Polypropylene (APP), Amorphous Poly Alpha Olefin (APAO), Thermoplastic Polyolefin (TPO), Styrene-Butadiene-Styrene (SBS), Styrene-Ethylene-Butadiene-Styrene (SEBS), Styrene-Isoprene-Styrene (SIS), synthetic rubber or other asphaltic modifiers, and may generally be reinforced with a polyester carrier or a combination of polyester and fiberglass. These sheets can be smooth or granular surfaced and are typically greater than 2.8 mm in thickness. The top surface of the cap sheet is exposed to the elements and hence the name “cap”. A base sheet is typically modified using any of the same modifiers as a cap sheet, but due to economic considerations, is modified using smaller quantities of less expensive polymers such as Atactic Polypropylene (APP) or Styrene-Butadiene-Styrene (SBS). A base sheet is generally reinforced with a fiberglass carrier (which costs significantly less than polyester) and is smooth surfaced. The thickness of such base sheet typically ranges from 1.0 mm to 2.5 mm depending upon the job specifications. In a typical field installation, a base sheet is first applied to the roof deck using mechanical fasteners, via torching, hot mopping, self adhesive, or cold application techniques. Cap sheets or shingles are applied on top of the base sheets, with the seams of adjacent rolls in offset relation. Most APP-modified bitumen membranes are torch-applied. Most SBS-modified bitumen membranes are set during in-field application in hot mopping asphalt, torch-applied, or adhered with cold-process adhesives, as described in U.S. Pat. No. 5,807,911 issued to Wentz, et al., on Sep. 1, 1992. Modified bitumen membranes which do not have factory-applied granule or foil surfacing typically need some form of field-applied ultraviolet protective coating.

Sheets which are sold as membranes in roll form may be cut into smaller sections to form shingles for use on roofs with greater slope. Shingles are typically nailed into place, and are most commonly used in residential roofing.

Another category of roofing membranes are “underlayments”, which are widely used in residential applications, and may also be designed for use in regions with colder climates, where ice-dam protection is required. Underlayments, commonly utilized under shingle roofing material, metal roofing panels or tile roofing, provide waterproofing characteristics and are typically reinforced with fiberglass. However, there are a few products in the marketplace that have no carrier such that these consist of simply a coating of self-adhesive compound on a polyolefinic film. Underlayments are typically used in steep slope roofing applications and, therefore, must provide good traction for the safety of the roofer installing the material. A typical underlayment installation involves mechanically fastening the same to the plywood substrate or adhering the underlayment to the plywood substrate using an adhesive compound.

Most underlayment materials designed to be used under metal roofing are based on SBS. Upon installation of such underlayment, metallic panels may be mechanically fastened to the top of the roofing underlayment. It is noted that metal generates excess heat and therefore necessitates the use of an underlayment that can withstand high temperature. Also granular surfaced products, whether APP or SBS based, are not recommended since the mineral surface can cause abrasion on the metal. This poses severe problems for the installer of such roofing underlayments in that these products are generally modified with styrene-butadiene-styrene (SBS) compound, which is soft and flows at temperatures above 110 degrees Celsius. Hence it is desirable to develop a product that has high heat resistance and a non-abrasive surface on the exposed side.

Upon installation of the underlayment, in the case of tile roofing, corresponding tiles that may be made of clay or concrete, are loaded to the top of the roofing underlayment. This poses several problems for the installer of the roof in that underlayments are generally thin (less than 2 mm in thickness), smooth surfaced, modified with SBS compound which is soft, and are reinforced with a fiberglass sheet that imparts very poor tear resistance properties to the membrane. Especially when the slope of the roof, commonly referred to as roof pitch, is steep, tiles that are stacked on top of the roof and can weigh from 80 to 100 lbs. per square foot of area, depending upon the type of tiles and the height of stacking, begin to slide down the roof and eventually fall on the ground. This poses a risk to people working on the roof and in the vicinity of the same, in addition to damage caused to the underlayment material, and lost installation time.

There are two major types of bituminous sheet materials used for roofing applications: bitumen-SBS and bitumen-APP materials. Of these, the bitumen-SBS products are more elastic, with greater flexibility at low temperatures. APP-based products, however, are more heat-resistant (due to a higher softening point), are more resistant against the effects of the atmosphere (especially ultra-violet rays) and more resistant to foot traffic

Known roofing materials, however, do not combine the benefits of SBS-modified bitumen materials and APP-modified bitumen materials. A given roofing material, e.g., roofing membrane, generally utilizes the rheological and mechanical properties of SBS-modified bitumen or APP-modified bitumen, but not both. This is due to the general incompatibility of SBS-modified bitumen compounds and APP-modified bitumen compounds. It is generally understood in the industry that an SBS-modified bitumen compound generally does not properly adhere directly to an APP-modified bitumen compound, because they have very different physical, mechanical and rheological properties which prevents a plastic material compatabilizing with an elastic material.

U.S. Pat. No. 6,696,125 discloses a self-adhered modified bitumen roofing material having a top APP-modified bitumen compound on a first side of carrier sheet and a relatively thin SBS-bitumen based adhesive compound on an opposite, second side of the carrier sheet, which provides a thin layer of SBS-bitumen adhesive on the bottom surface of the APP-modified membrane. This allows for an APP-modified roofing material that is easy to install under the proper conditions. Although the thin SBS-bitumen lower portion provides self-adhesivity, it otherwise does not impart substantial rheological and mechanical properties to the roofing material. Thus, the roofing material has substantially the properties of an APP-modified bitumen subsequent to installation.

There remains a need, therefore, for a roofing material (e.g., a roofing membrane) that has the substantial advantageous properties of SBS-modified bitumen roofing members (e.g., elasticity , cushion, and low temperature flexibility) and the advantageous properties of APP-modified bitumen roofing members (e.g., weather resistance and surface properties).

There is also a need for a roofing material having an APP-modified outer surface that is versatile with respect to application, e.g., it can be applied using the standard methods including torching hot-mopping (e.g., using a hot SBS-modified asphalt mopping compound), or a cold process adhesive, depending on the requirements of a particular application.

“Torching” is a method of application generally used for APP-modified membranes in which the back surface of the rolls is heated. Heating of the bitumen-based roofing membranes is typically carried out by use of propane gas burners or torches. When the flame, which has a typical temperature of 1,000 to 1,300 degrees Celsius is directed towards the bottom surface of the sheet, APP compound from the bottom surface reaches a molten state and starts to flow on to the substrate and then cools to form a waterproofing bond.

SBS membranes, on the other hand, are typically applied by the generally more convenient hot mopping or cold process adhesive methods, although they can also be applied by torching. In a hot mopping application, drums or “kegs” of hot asphalt (e.g., hot SBS-modified asphalt, blown asphalt (type 3 or 4)) are used. Alternatively, hot asphalt may be directly pumped to the roof from the ground using a hose. The hot asphalt is applied by mopping the hot asphalt, using a mop or series of chains, between the roofing material, e.g., membrane, and the roof surface, which are then joined to form a waterproofing bond. Cold process adhesives generally come in pails or pressurized spray can systems. In a cold process adhesive application, cold adhesives are applied to the roofing material during installation, then joined to the roof surface to form a waterproofing bond.

For a given substrate/application, one of the above-described in-field applications may be more desirable than the others. For example, a particular climate or the particularities of a given roof may warrant using one of the above-mentioned application methods instead of the others. Thus, when a roofing material is only suitable for one of the methods (e.g., torching, hot mopping, or cold adhesion), the installer may be forced to use a less than optimal installation method, or worse, may not be able to properly install the roofing material, which would require using a different roofing material. This may require an installer to stock various types of roofing materials for varying applications, which may add substantial cost. Similarly, from a manufacturing standpoint, a supplier would generally need to have separate production lines to provide the various types of roofing materials to meet the customer's needs. There is, therefore, a need to provide a modified bitumen roofing membrane which provides flexibility with regard to installation methods.

One object of the present invention is to provide a dual-compound multi-protective-layer roofing material, particularly cap materials. Preferably the roofing material includes an APP-based compound on the weathering surface and an SBS-based compound on the back surface. Such membranes are ideal where the advantageous properties of both SBS-based membranes and APP-based membranes are desired. The thickness of such membranes is between 3.5 mm and 5.0 mm for granulated and smooth (non-granulated) surfaces. Typical weight of a one square roll (1 roofing square equals 107.6 square feet) is between 90 pounds and 115 pounds, depending upon thickness of the membrane. Such membranes may be reinforced with a polyester, fiberglass or polyester/fiberglass combination mat or poly/glass scrims. Generally, fiberglass is not used as a carrier in cap sheets.

Still another object of the present invention to provide a unique APP-modified bitumen compound on the top surface that is substantially harder than the bottom surface. This is particularly useful for underlayments. When metal panels heat up during the daytime, especially in summer, heat is transferred to the underlayment below. This transfer of heat softens the modified compound and causes the compound to flow. This effect is greater with SBS-modified bitumen underlayments. Typical softening point temperatures of APP modified compound is in excess of 150 degrees Celsius, whereas that of conventional SBS modified compound is approximately 120 degrees Celsius. Use of a hard APP outer compound alleviates this problem.

Yet another object of the present invention is to provide membranes with well-embedded mineral granular surface that is coarse enough to resist any movement of the tiles in a downward fashion by offering a non-skid surface and a higher coefficient of friction. When roofing tiles begin to move, they first “sink” into the soft SBS compound used in most existing underlayments, causing damage to the fiberglass reinforcement, and then slide downwards. Use of a hard APP-based compound above the softer SBS-based compound makes it nearly impossible for the tiles to “sink” into the compound and thereby helps prevent damage to the fiberglass mat used as support.

Yet another object of the present invention is to provide APP-modified bituminous, non-self-adhesive shingles, referred to as modified shingles, having an SBS-modified bituminous lower layer and reinforced with a combination of polyester and fiberglass reinforcements. Shingles, commonly employed in residential applications and typically manufactured using filler modified asphalt and fiberglass support, are applied to the roof deck using nails. However, APP-modified shingles and SBS-modified shingles exist in the market. A feature of example embodiments of the present invention is shingles with a dual-compound multi-protective-layer structure--one or more APP-modified compounds on the top surface and one or more SBS-modified compounds on the bottom surface. Moreover, the shingles may be reinforced with a dual carrier—polyester and fiberglass—to impart the best characteristics of both reinforcements to the shingles.

APP modified bitumen compound by itself is not easily applied using hot-mopping or cold adhesives, particularly those based on SBS. As such, APP-modified bitumen materials are typically applied only with torching, which limits the options an installer has for applying the material. This is a disadvantage, as there are situations where torching is not desired or may cause increased danger, e.g., of fire. Further, APP-modified bitumen materials lack the elasticity and cold-weather flexibility of SBS-modified bitumen materials, which are desirable for a lower or base portion of a roofing material. SBS-modified compounds, while more adaptable with regard to installation, do not have the desirable hardness, temperature and weathering resistance, and surface features of APP-modified materials that are desirable for outwardly facing portions of the roofing material, thereby leading to, e.g., premature degradation with exposure to the elements. Example embodiments of the present invention combine the advantages of an APP-based material and the advantages of an SBS-based material without the respective disadvantages. An advantage of a dual-compound multi-protective-layer structure, e.g., membrane, of example embodiments of the present invention is the ability to add a roofing compound such as an APP-modified bitumen on the top (weathering) surface and a substantial layer of SBS-modified compound on the bottom surface.

Example embodiments of the present invention deal with applying a dual-membrane multi-protective-layer to the reinforcement carrier sheet, for example, an Atactic Polypropylene (APP) or Amorphous Poly Alpha Olefin (APAO) or Thermoplastic Polyolefin (TPO)-modified bitumen compound on the top surface, and a non-adhesive styrene-butadiene-styrene (SBS)-modified bitumen compound to the bottom surface of the reinforcement carrier sheet.

The APP-modified compound utilized on the top surface offers plastomeric characteristics to the bitumen and makes the membrane very hard and imparts improved flow resistance at high temperatures. The SBS-modified compound utilized on the bottom surface offers elastomeric characteristics and allows a lower portion of the membrane to be elastic and flexible, e.g., at low temperatures and further provides a cushioning effect to the harder top layer. It also allows for versatility in applying the membrane to the substrate, including ease of hot mopping application, cold adhesive application, and/or torching to affix the membrane to, e.g., a roof deck, base sheet or underlayment.

Example embodiments of the present invention involve roof coverings in the form of roofing membranes and shingles having a top layer of an APP-modified bituminous compound, whose composition utilizes bitumen (asphalt), APP plastomeric modifiers and fillers, and a bottom layer of a non-self-adhesive SBS-modified compound, whose composition utilizes bitumen (asphalt), elastomeric modifiers, and fillers. All percentages used herein are by weight. A typical APP compound may contain 5% to 25% of polypropylene modifiers, 8% to 70% of filler such as limestone or talc, and remaining portions of asphalt. In order to achieve fire ratings as classified by Underwriters' Laboratories (UL), special fire retardant additives may be used as filler such as colemanite or ATH. A typical non-self-adhesive SBS-modified compound may contain 5% to 10% of SBS modifiers, 5% to 50% of filler such as limestone, talc, fly ash, volcanic ash, graphite, carbon black, silica or china clay, and remaining portions of asphalt. The SBS-modified compound is free, or substantially free, of tackifying additives (e.g., NP25 hydrocarbon resin or other tackifying resins and styrene-isoprene-styrene modifiers).

The membrane according to example embodiments of the present invention has a carrier that functions as a support for multiple protective layers, i.e., an APP modified asphaltic compound layer which is positioned on top of the carrier sheet, and a non-self-adhesive SBS-modified asphaltic compound layer which is positioned below the carrier sheet.

The example embodiments may be applied using any standard application technique. In addition, they may be provided with an additional adhesive layer to allow for self-adhesive application.

Furthermore, when applying example embodiments of the present invention to underlayments, surfacing agents may be applied to the upper-exposed surface of the roofing membrane. In the case of metal roofing underlayments, a suitable surfacing agent such as polyester or polypropylene fabric, of thickness 0.05 mm to 0.15 mm and of unit weight 20 to 60 grams per square meter, can be applied to the weathering surface of the roofing membrane to provide high temperature resistance. Polyester and polypropylene materials have higher softening point and, therefore are less susceptible to heat than polyethylene; hence the selection of these fabrics for this invention.

Similarly, in the case of tile roofing underlayments, a suitable surfacing agent such as mineral granules can be applied to the weathering surface of the roofing membrane to provide slip resistance. When selecting granules for this application, it is critical to note that the granule size must not be too small so as not to provide the required slip resistance and not too big to pose a problem in manufacturing. Typical granule screen grading are as follows: 40% to 55% by weight passing U.S. standard sieve #16, 15% to 45% by weight passing U.S. standard sieve #20.

The novel roofing membrane preferably comprises: a carrier sheet with a top surface and a bottom surface; and a top layer applied to the top surface of the carrier sheet; a bottom layer applied to the bottom surface of the carrier sheet. The top layer comprises an APP-modified bitumen compound, preferably comprising a mixture of: (a) 5% to 25% polypropylene modifiers comprised of isotactic polypropylene, ethylene-propylene copolymer, atactic polypropylene and polyethylene, (b) 8% to 70% of filler, and (c) 45% to 75% bitumen. The bottom layer comprises an SBS-modified bitumen compound, e.g., comprised of a mixture of: 5% to 10% of Styrene-butadiene-styrene modifiers, 5% to 50% of filler such as limestone, talc, fly ash, volcanic ash, graphite, carbon black, silica or china clay, and remaining portions of asphalt. The SBS-modified compound is free, or substantially free, of tackifying additives (e.g., NP25 hydrocarbon resin or other tackifying resins and styrene-isoprene-styrene modifiers). The carrier sheet is impermeable to both the APP-modified bitumen compound and the SBS-modified bitumen compound, or at least resistant enough to permeation of these compounds to prevent substantial intermingling thereof. Thus, the carrier sheet is selected to bond to both the APP-modified bitumen layer and the SBS-modified bitumen layer, but at the same time isolate, or substantially isolate, the APP-modified bitumen layer from the SBS-modified bitumen layer.

The thickness of the top layer may be any appropriate thickness, e.g., from 1 mm to 3 mm, in order to provide the desirable characteristics of APP-modified roofing products, e.g., surface traction and weathering resistance, including a high level of resistance from thermal and UV degradation. The carrier sheet typically may have a thickness from 0.2 mm to 1 mm. The bottom layer may have a thickness that is, e.g., between 0.7 mm and 3.0 mm, preferably between 1.0 mm and 2.0 mm, more preferably between 1.3 mm and 1.8 mm, and most preferably a thickness of 1.5 mm.

Further features and aspects of example embodiments of the present invention are described in more detail below with reference to the appended Figures.

### BRIEF DESCRIPTION OF THE DRAWINGS

FIG. 1 is an exploded view of the roofing membrane composite sheet.

FIG. 2 is a top view of the composite sheet of FIG. 1 on a roofing substrate structure.

FIG. 3 is a non-exploded, partial cross-sectional view, through plane I-I, of the roofing membrane composite sheet of FIG. 1.

FIG. 4 is a non-exploded, partial cross-sectional view, through plane I-I, of the roofing membrane composite sheet of FIG. 1 on a roofing substrate structure.

### DETAILED DESCRIPTION

In example embodiments of the present invention, the modified bitumen roofing member is a membrane having a dual-compound multi-protective-layer composition constructed of a first APP-modified asphaltic layer on the front side of a carrier sheet and a second, non-self-adhesive, SBS-modified asphaltic layer on the back side of the carrier sheet. The first asphaltic layer provides the advantageous qualities of APP-based roofing, e.g., surface traction and weathering resistance, including a high level of resistance from thermal and UV degradation, while the second asphaltic layer provides the advantageous qualities of SBS-based roofing materials, e.g., substantial elasticity, cold-weather flexibility, cushioning, and ease and adaptability of installation.

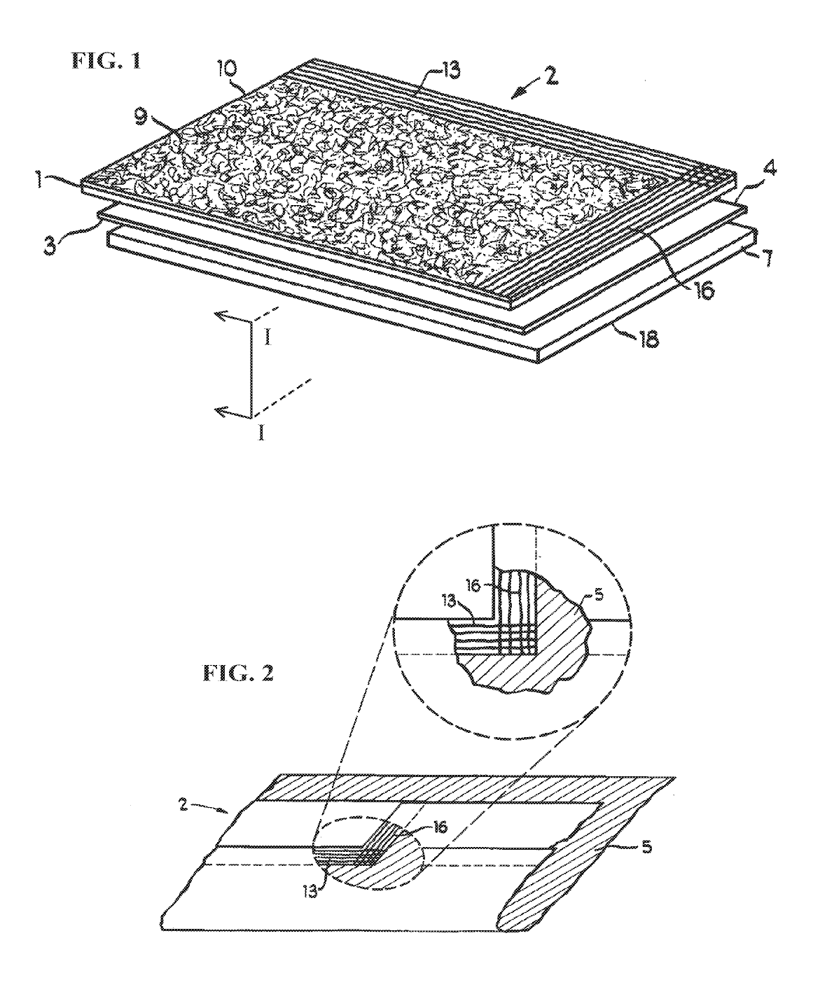

Referring now to the drawings, FIG. 1 represents a bituminous membrane constructed in accordance with the present invention and is shown in an exploded view. The composite sheet 2 is made with modified asphalt coatings and a reinforcing carrier sheet 4. Specifically, composite sheet 2 includes a reinforcing carrier 4 sandwiched between top and bottom layers, 1 and 7, respectively, of modified bitumen coatings, which form oppositely exposed upper and lower surfaces, 9 and 18, respectively, of the composite sheet 2. The bottom layer 7 has a non-adhesive polymer-modified compound that constitutes a non-weathering surface adapted to be secured to the underlying surface. The top layer 1 is an APP compound (described in detail later in the description) and the bottom layer 7 is a separate SBS compound (also described in detail later in the description). Between the top and bottom layers, 1 and 7 respectively, is a reinforcing carrier sheet core 4, preferably made of a fiberglass or polyester substrate. Alternatively, the reinforcing carrier sheet 4 may be formed of a composite material that is a combination of both polyester and fiberglass creating a stronger reinforcement carrier sheet 4. As will become hereinafter apparent, the lower exposed surface 18 of the bottom layer 7 is a non-weathering surface adapted to be adhered to the underlying surface by any one or more of torching, hot-mopping (e.g., using a hot SBS-modified asphalt mopping compound), and application of a cold adhesive, depending on the requirements of the particular application.

Although it is preferable that the layer 7 be the lowermost exposed layer to allow for torching, hot mopping, and/or application of cold adhesives, it should be understood that one or more additional lower layers may be applied below the layer 7 (e.g., a thin, self-adhesive layer such as described in U.S. Pat. No. 6,696,125). Surfacing agents 10, such as granules, talc or sand for cap sheets and base sheets, fabric surfacing for metal underlayments or mineral granules for tile underlayments, may be applied to the upper surface of the top asphaltic coating layer 1 to impart weathering, high temperature resistant characteristics and skid resistant characteristics. Further, the top layer 1 may be uncoated and/or include a reflective component, e.g., a pigment such as a white pigment formed, e.g., of titanium dioxide. The top layer 1 may optionally include additional asphaltic layers.

The lower exposed surface 18 of the bottom layer 7 provides an exposed, SBS-modified non-self-adhesive asphaltic surface suitable for any one or more of torching, hot-mopping (e.g., using a hot SBS-modified asphalt mopping compound), and application of a cold adhesive, during, e.g., application to the underlying surface or roof deck. The top APP compound layer 1 of the composite sheet 2 can either be smooth surfaced or surfaced with a protective layer of surfacing agents 10, such as granules, as shown in FIG. 1. This upper surface 9 constitutes a surface exposed to weather conditions or possibly to other membranes or shingles.

The top APP compound layer 1 comprises a mixture consisting of the following: 5% to 25% of a mixture of polypropylene modifiers comprising of (a) isotactic polypropylene; (b) ethylene-propylene copolymer; (c) atactic polypropylene, and (d) polyethylene, preferably film grade material, 8% to 70% of filler such as limestone, talc, fly ash, volcanic ash, graphite, carbon black, silica or china clay, and 45% to 75% of asphalt. Polyethylene used in the APP formulation can be high density polyethylene (HDPE) or low density polyethylene (LDPE), virgin or recycled material. APP formulations may be adjusted slightly to account for seasonal temperature fluctuations, such as, e.g., very hard compound to be used during summer months and a compound with medium hardness to be used during the winter months. In the place of APP, commercially available Thermoplastic Olefin (TPO) can be substituted as well. Such a mix should have a viscosity of 2,000 to 20,000 cPs at 180 degrees Celsius, a ring and ball softening point temperature greater than 130 degrees Celsius, and a needle penetration value of 65 dmm at 60 degrees Celsius for the dual-compound multi-protective-layer cap sheet, and less than 50 dmm at 60 degrees Celsius for the tile underlayment and metal underlayment, with a preferred range of 40 to 140 dmm. All tests values are determined using appropriate ASTM test methods and standards. The APP compound may contain a tackifying resin in amounts ranging from 0% to 2% to improve adhesion at lap joints. Additionally, in order to achieve fire ratings as classified by Underwriters' Laboratories (UL), special fire retardant additives may be used as filler material. Typical fire retardants employed include calcium borate, magnesium borate, a mixture of antimony tri-oxide and deca bromo diphenyl oxide, etc. These are used as replacement for existing filler material such as limestone, talc, fly ash, volcanic ash, graphite, carbon black, silica or china clay or in conjunction with these filler materials. A minimum of 10% of the fire retardant material is required to achieve the desired performance during fire testing.

The bottom non-self-adhesive SBS-modified layer 7 of the dual-compound multi-protective layer asphaltic coating is applied on the backside 3 of the carrier sheet 4. The bottom SBS-modified layer 7 generally comprises a mixture of the following ingredients: 5% to 10% of styrene-butadiene-styrene copolymer, 5% to 50% of filler such as limestone, talc, fly ash, volcanic ash, graphite, carbon black, silica or china clay, and the balance being asphalt. The bottom layer 7 is free, or substantially free, of styrene-isoprene-styrene copolymer and hydrocarbon tackifying resins.

With the non-self-adhesive bottom SBS-modified layer 7 being pre-applied, all that is required at the jobsite is for the applicator to unroll the composite sheet and adhering the composite to the underlying surface as stated above by, e.g., hot mopping, torching, or applying a cold adhesive between the bottom layer 7 and the underlying surface.

Referring now to FIG. 2, the composite sheet 2 is shown as applied to the underlying surface, which can be the roof deck itself or another base sheet or underlayment. The composite sheet 2 is shown with a cut-out exploded view illustrating the side lap 13 and the end lap 16. The side lap 13 runs longitudinally along one lengthwise edge of the composite sheet 2, whereas the end lap 16 runs widthwise along one end of the composite sheet 2. As illustrated, the composite sheet 2 is applied to the underlying surface 5 in successive rows. The composite sheets 2 can be adhered to each other along the side laps 13 and end laps 16 to create a watertight or connecting bond between successive or adjacent composite sheets 2.

The dual-compound multi-protective-layer modified bitumen composite sheet 2 may be manufactured by a coating process by which the APP-modified top-layer 1 and the SBS-modified bottom layer 7 are coated on respective sides of the reinforcement sheet 4.

In other example embodiments of the present invention, a “burn-off” film (not illustrated), that is approximately 4 inches in width, is placed along the length of the roll on one side of the composite sheet 2, forming a side lap 13. This allows for overlapping one roll over another widthwise.

Similarly, a siliconized polyester end lap film (not illustrated), that is approximately 4 to 6 inches in width, is positioned across the width of the sheet at regular intervals to provide a granule-free end lap 16. For more detail on the end lap protection of a roll of roofing membrane see U.S. Pat. Nos. 5,843,522 and 5,766,729, which are assigned to the assignee of the inventions described herein and which are incorporated by reference in their entireties herein. The protected end lap 16 feature allows a granule-free surface at the end of each roll and facilitates easy installation when overlapping one roll over another lengthwise.

Also removed at the time of roof covering installation are the burn-off film and the end lap film 15. The burn off film tape, called selvage film, that is typically 3 to 4 inches in width is applied on the selvage of the sheet using a selvage film applicator (4) and immediately following, a siliconized polyester tape, which is typically 4 to 6 inches in width, is applied across the sheet every 10 meters using an applicator device (5).

A preferred example embodiment includes a bottom SBS layer 7 comprising by weight percent: 8% SBS, 27% calcium carbonate (filler) and the remainder Asphalt (AC-5 around 150 pen). The total thickness of the preferred example embodiment is about 4 mm with a 2.0 mm to 2.5 mm top APP-modified layer-1 and a 1.5 mm bottom SBS-modified layer 7. The reinforcement sheet 4 of the preferred example is comprised of 100% polyester or polyester with glass yarns/scrim. The basis weight of the reinforcement sheet 4 would be a min. of 170 gsm (grams per square meter).

In another preferred embodiment, the carrier sheet comprises a polyester reinforcement in the case of APP-modified non-self-adhesive cap sheet or a fiberglass reinforcement in the case of tile underlayment and metal underlayment. The membrane includes a first APP-modified asphaltic coating portion and a second non-self-adhesive SBS-modified bitumen coating portion. These two components may be present over a wide compositional range. A minimum thickness of the non-self-adhesive SBS-modified portion to provide a well-adhered protective layer (e.g., when hot mopped), however, is important, preferably the minimum thickness is above 0.7 mm.

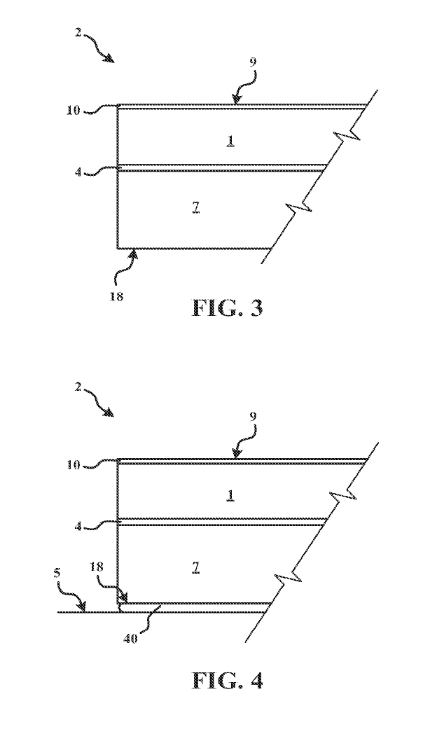

FIG. 3 is a non-exploded partial cross-sectional view, taken along the plane I-I of the roofing membrane composite sheet of FIG. 1. As such, the partial cross-sectional view is taken through a plane perpendicular to the upper and lower surfaces 9 and 18. As described above, the top layer 1, formed of an APP-modified bitumen compound, is separated by reinforcing carrier 4, which is sandwiched between top and bottom layers 1 and 7. The thickness of the top layer 1 may be any appropriate thickness, e.g., from 1 mm to 3 mm, in order to provide the desirable characteristics of APP-modified roofing products, e.g., surface traction and weathering resistance, including a high level of resistance from thermal and UV degradation. The reinforcing carrier 4 typically has a thickness from 0.2 mm to 1.0 mm. As regards the bottom layer 7, it is important that this SBS-modified bitumen layer have sufficient thickness to impart the beneficial properties of an SBS-modified roofing products, e.g, protective cushioning, impact resistance, flexibility, elasticity and adaptability and ease in methods of installation. In this regard, the bottom layer 7 should also have a thickness sufficient to provide a well-adhered protective layer, e.g., when hot mopped.

Example embodiments may have a bottom layer 7 thickness that is between about 0.7 mm and 3.0 mm. In some preferred embodiments, the bottom layer 7 has a thickness between about 1.0 mm and about 2.0 mm. In more preferred embodiments, the bottom layer 7 has a thickness between 1.3 mm and 1.8 mm. Most preferably, the bottom layer 7 has a thickness of about 1.5 mm

FIG. 4 is a non-exploded partial cross-sectional view, taken along the plane I-I of the roofing membrane composite sheet of FIG. 1 on the roofing substrate structure 5, which forms an underlying surface to which the roofing composite sheet 2 is joined. Layer 40 represents a hot-mopped layer (e.g., an SBS-based hot mopping compound) used to attach the bottom layer 7 (and thus the composite roofing sheet 2) to the underlying base structure 5. For cold adhesive applications, the layer 40 represents a cold adhesive applied between the bottom surface 18 of the bottom layer 7 and the structure 5. Where a torching application is desired, the layer 40 would be omitted and the bottom layer 7 would directly contact the base structure 5. Moreover, should a self-adhesive configuration be desired, layer 40 would represent the factory-applied self-adhesive layer, e.g., a self-adhesive, SBS-modified bituminous layer applied to the bottom surface of the non-self-adhesive SBS-modified bituminous bottom layer 7. This optional self-adhesive layer optionally contains, e.g., SIS and/or one or more tackifying agents.

As set forth above, example embodiments of the present invention provide for a composite roofing sheet, e.g., membrane, that has the beneficial properties of an APP-based roofing product, as well as the beneficial properties of an SBS-based roofing product, while also allowing for enhanced adaptability in the method of installation (e.g., hot mopping, torching, or cold adhesive application) the installer chooses.

What is claimed is:

1. A roofing membrane, comprising:
a carrier sheet having a top surface and a bottom surface;
a top layer of an APP-modified bitumen compound applied to the top surface of the carrier sheet; and
a bottom layer of a non-self-adhesive SBS-modified bitumen compound applied to the bottom surface of the carrier sheet,
wherein the carrier sheet substantially isolates the APP-modified bitumen compound from the non-self-adhesive SBS-modified bitumen compound.

2. The roofing membrane of claim 1, wherein the top layer comprises a mixture of: (a) 5% to 25% polypropylene modifiers comprised of isotactic polypropylene, ethylene-propylene copolymer, atactic polypropylene and polyethylene, (b) 8% to 70% of filler, and (c) 45% to 75% bitumen.

3. The roofing membrane of claim 2, wherein the bottom layer comprises a mixture of: (a) 5% to 10% of Styrene-butadiene-styrene modifiers, (b) 5% to 50% of filler such as limestone, talc, fly ash, volcanic ash, graphite, carbon black, silica or china clay, and (c) remaining portions of asphalt.

4. The roofing membrane of claim 1, wherein the SBS-modified bitumen compound is substantially free of tackifying additives.

5. The roofing membrane of claim 1, wherein the carrier sheet is impermeable to both the APP-modified bitumen compound and the SBS-modified bitumen compound.

6. The roofing membrane of claim 1, wherein the carrier sheet is formed of a fiberglass substrate.

7. The roofing membrane of claim 1, wherein the carrier sheet is formed of a polyester substrate.

8. The roofing membrane of claim 1, wherein the reinforcing carrier sheet is formed of a composite material that is a combination of both polyester and fiberglass.

6. The roofing membrane of claim 1, wherein roofing membrane is a cap material.

7. The roofing membrane of claim 1, wherein the roofing membrane is an underlayment.

8. The roofing membrane of claim 1, wherein the membrane has a thickness in a range of 3.5 mm to 5.0 mm.

9. The roofing membrane of claim 8, wherein the carrier sheet has a thickness in a range of 0.2 mm to 1 mm.

10. The roofing membrane of claim 9, wherein the bottom layer has a thickness that is in a range of 0.7 mm to 3.0 mm.

11. The roofing membrane of claim 9, wherein the bottom layer has a thickness that is in a range of 1.0 mm to 2.0 mm.

12. The roofing membrane of claim 9, wherein the bottom layer has a thickness that is in a range of 1.3 mm to 1.8 mm.

13. The roofing membrane of claim 9, wherein the bottom layer has a thickness of 1.5 mm.

14. The roofing membrane of claim 9, wherein the top layer is in a range of 1 mm to 3 mm.

15. A roofing membrane, comprising:
a carrier sheet having a top surface and a bottom surface;
a top layer of an TPO-modified bitumen compound applied to the top surface of the carrier sheet; and
a bottom layer of a non-self-adhesive SBS-modified bitumen compound applied to the bottom surface of the carrier sheet,
wherein the carrier sheet substantially isolates the TPO-modified bitumen compound from the SBS-modified bitumen compound.

16. The roofing membrane of claim 15, wherein the TPO-modified bitumen compound has a viscosity of 2,000 to 20,000 cPs at 180 degrees Celsius, a ring-and-ball softening point temperature greater than 130 degrees Celsius.

17. The roofing membrane of claim 16, wherein the TPO-modified bitumen compound has a needle penetration value of 65 dmm at 60 degrees Celsius.

18. The roofing membrane of claim 16, wherein the TPO-modified bitumen compound has a needle penetration value of less than 50 dmm at 60 degrees Celsius for the tile underlayment and metal underlayment.

19. The roofing membrane of claim 16, wherein the TPO-modified bitumen compound has a needle penetration value in a range of 40 to 140 dmm.

20. A roofing membrane, comprising:
a carrier sheet having a top surface and a bottom surface;
a top layer of an APP-modified bitumen compound applied to the top surface of the carrier sheet; and
a bottom layer of a non-self-adhesive SBS-modified bitumen compound applied to the bottom surface of the carrier sheet,
wherein the carrier sheet is sufficiently resistant to permeation of both the APP-modified bitumen compound and the non-self-adhesive SBS-modified bitumen compound to substantially prevent intermingling of the APP-modified bitumen compound and the non-self-adhesive SBS-modified bitumen compound.
